(19) United States
(12) Patent Application Publication
(10) Pub. No.: US 2012/0274773 A1
(43) Pub. Date: Nov. 1, 2012

(54) GOLF GAME AND REALITY TELEVISION SHOW

(76) Inventors: Isaac S. DANIEL, Miramar, FL (US); Stephen HAYWARD, Maidenhead (GB)

(21) Appl. No.: 13/456,024

(22) Filed: Apr. 25, 2012

Related U.S. Application Data
(63) Continuation of application No. 12/378,066, filed on Feb. 11, 2009.
Application No. 12/378,066 is a continuation-in-part of application No. 12/454,162, filed on May 13, 2009, now Pat. No. 8,249,254.
Application No. 12/454,162 is a continuation-in-part of application No. 12/614,122, filed on Nov. 6, 2009.
Application No. 12/614,122 is a continuation-in-part of application No. 12/378,066, filed on Feb. 11, 2009.
Application No. 12/378,066 is a continuation-in-part of application No. 13/448,001, filed on Apr. 16, 2012.
(60) Provisional application No. 61/478,834, filed on Apr. 25, 2011.

(30) Foreign Application Priority Data
Dec. 16, 2008 (US) PCT/US2008/013755

(51) Int. Cl. H04N 7/18

(52) U.S. Cl. 348/157; 348/E07.085

(57) ABSTRACT

A method for conducting a reality golf television show, comprising conducting a selection process, wherein the selection process comprise: a first component based on participants' driving range ability, oral skills, attitude, and golf knowledge; a second component based on participants' golf course performance, wherein, the selection is performed by collecting votes from viewers via a communications network, conducting a team-play golf tournament, and following each of the television show's participants with a camera and recording their everyday lives throughout the television show.

### PRIORITY CLAIM

The present application is a Continuation-in-Part of U.S. Provisional Patent Application Ser. No. 61/478,834, filed on Apr. 25, 2011, titled “Golf Reality Television Show,” filed on Apr. 25, 2011, by Isaac S. Daniel, et al; U.S. patent application Ser. No. 13/448,001, titled “Golf Game and Scoring Method,” filed on Apr. 16, 2012, by Isaac S. Daniel, et al; U.S. patent application Ser. No. 12/378,066, titled “A Game Apparatus, System, and Method for Improving In-Game Communications During a Game Ser. No. 12/378,066, filed on Feb. 11, 2009, by Isaac S. Daniel, et al; U.S. patent application Ser. No. 12/454,162, titled “An Apparatus, System and Method for Reporting a Player's Game Plays During a Game,” filed May 13, 2009, by Isaac S. Daniel; and U.S. patent application Ser. No. 12/614,122, titled a “System and Method of Distributing Game Play Instructions to Players During a Game,” filed on Nov. 6, 2009, by Isaac S. Daniel, whose priorities are claimed, and which are hereby incorporated by reference as if fully stated herein.

### FIELD

The present disclosure relates generally to games and sports, and more specifically, to the game of golf and television shows related to golf.

### BACKGROUND

Traditionally, golf has been played as a game which emphasizes the skills of the individual player, and their ability to complete a hole in as few shots as possible. Because golf is an individual sport, a player has traditionally been required to possess a broad range of skills for various types of shots, such as driving the ball, hitting the ball in the rough or sand trap, hitting the ball on the fairway, chipping, and putting. Furthermore, the player has been charged with ultimately determining their game's strategy, such as club selection, ball spin, and shot strategy (i.e. whether to try and shoot directly for the green and risking an overshot, or attempting to lay up and chip onto the green).

The individualistic nature of golf has been criticized as being boring and uninteresting, since the pace of the game is generally slow and if a certain player is having an off day, they usually do not stand a chance at winning

### SUMMARY

The various embodiments of games and methods described herein result from the realization that the game of golf and television shows based on golf may be made more interesting and exciting by providing an in-depth golf reality television show based on a new golf game and scoring system that combines the traditional rules of golf with team play, and incorporates the time into the scoring system.

Accordingly, the various embodiments and disclosures described herein solve the limitations of the prior art in a new and novel manner.

### BRIEF DESCRIPTION OF THE DRAWINGS

FIG. 1A shows a score record for a game according to one embodiment;

FIG. 1B shows a diagram depicting a golf hole in accordance with one embodiment;

FIG. 1C shows a block diagram depicting a method in accordance with one embodiment; and

FIG. 2 shows an apparatus in accordance with one embodiment.

### DETAILED DESCRIPTION OF PREFERRED EMBODIMENTS

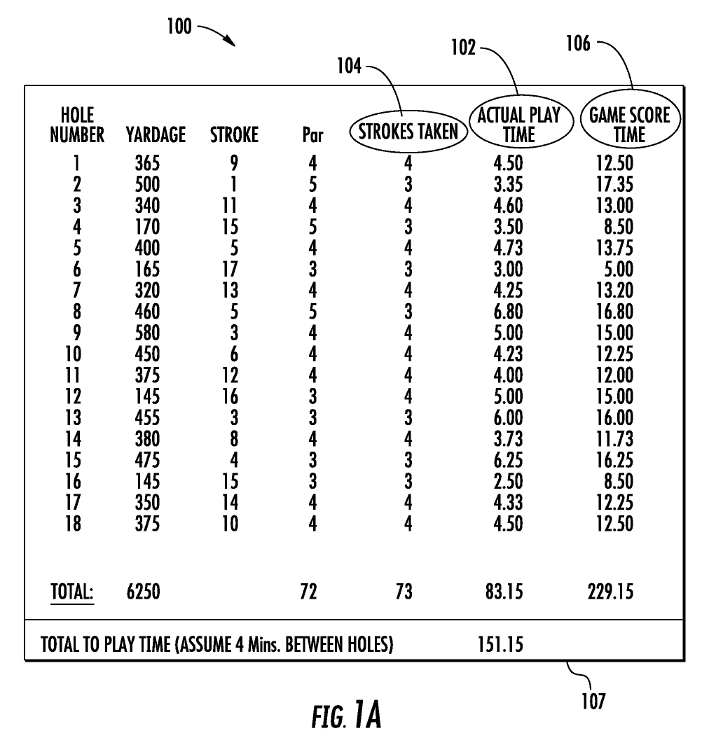

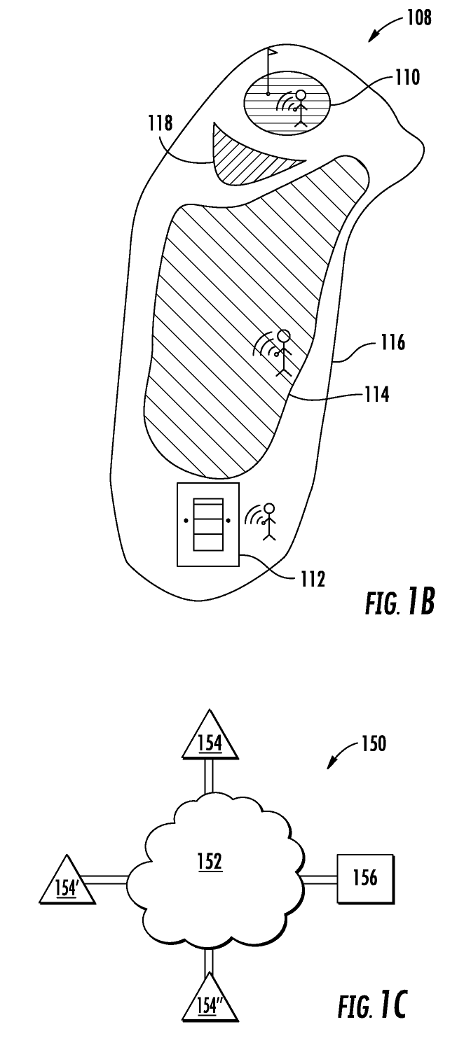

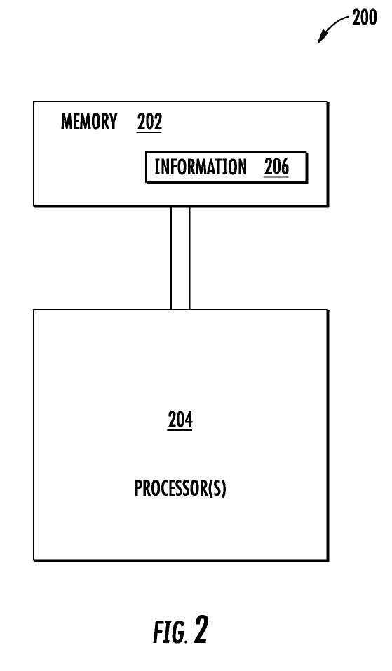

Referring now to FIG. 1A, a table 100 depicting a score record for game carried out using a method for playing and scoring a golf game, wherein the method comprises determining an actual time 102 it takes to complete a golf hole, determining a number of strokes 104 taken by the team in completing the golf hole, multiplying the number of strokes taken by the team in completing the golf hole by a predetermined amount of time to determine an added shot time, determining a total hole time 106 by adding the added shot time to the actual time it takes the team to complete the golf hole, and recording the total hole time 106 on a score keeping means 107.

In some embodiments, the term “golf” refers to the game of golf as played according to the traditional rules, however in some embodiments the traditional rules may be modified, redacted, or amended as described herein.

The term “predetermined amount of time”, as used herein, may refer to any predetermined amount of time, as measured in seconds, minutes, hours, or any other unit of time. The amount of time may be predetermined at any point, or may be determined in real time, or instantly.

In some embodiments the time it takes to complete a golf hole is measured from the point at which the ball is teed off until the ball is holed.

The number of strokes taken by a team in completing the golf hole may include the number of strokes taken by the team as a whole.

Score keeping means 107 may comprise any type of score keeping means, such as, but not limited, paper golf scorecard, or an electronic score keeping means, such as, but not limited to a digital golf scorecard.

In some embodiments, the golf hole may comprise a traditional golf hole, such golf hole 108 (shown in FIG. 1B), which may include a green 110, a tee box 112, a fairway 114, a rough 116, a sand trap 118, a water hazard (not shown), amongst other things.

In one embodiment, the method may further comprise requiring that the team comprise of a plurality of players, wherein each player may be responsible for at least one specific skill or at least one specific shot. The at least one specific skill may be any kind of skill, such as a driving skill, a putting skill, a chipping skill, a short iron skill, a long iron skill, a sand trap skill, a rough skill, and a trick shot skill. A trick shot skill may include skipping the ball off of a surface, such as water, cement, and the like. The at least one specific shot may be any kind of shot, such as a drive, a fairway shot, a rough shot, a sand trap shot, a chip, a putt, a trick shot, a slice, a draw, a fade, a hook, a push, a pull, a backspin shot, a forward spin shot, a side spin shot, a lob, a skip, a shot, a thin shot, and a sky hook. The players make take turns in being responsible for a specific shot or skill throughout the game.

In some embodiments, the method may further comprise requiring team members to take consecutive turns playing the same ball beginning with the tee off and continuing until the ball has been holed. In a further embodiment, the method may require that each team member charged with at least one specific skill or at least one specific shot play the ball in the lie that requires each team member's specific skill or specific shot.

For example, the player responsible for driving the ball may tee off, then the player responsible for a long iron shot may hit the next shot, the following player responsible for the short range shots may chip the ball on the green, and then the player responsible for putting may putt the ball in the hole.

In some embodiments, the method may require that no single team member play a consecutive shot, so that each player cannot play the next stroke after they have played.

In yet a further embodiment, the method comprises requiring that no single team member tee off on consecutive holes, so that each player cannot tee off on two consecutive holes.

In yet another embodiment, the method may require that a tee off on one hold commence within a predetermined amount of time after completion of a prior hole. Such a rule would speed up the game and make it more exciting for players and spectators alike. In the various embodiments of the method where time constraints are called for, the time constraint may make the game more exciting and speedy for players and spectators alike.

To make the game more interesting, the method may require determining a penalty time by multiplying at least one predetermined amount of time by a number of penalties committed during a hole. The total time may comprise the actual time to complete a hole plus the added shot time, plus penalty. It should be noted that in the various embodiments described throughout the present disclosure where a certain time amount or value is assigned to a particular occurrence or event, a predetermined point value may be used instead. In other words, a predetermined time amount, such as the penalty time, may be substituted by a score deduction.

The penalty may be any kind of penalty, such as a lost ball, a hazard, a mulligan, striking the ball into a penalty zone, or other traditional golf penalties. The penalty zone may be a designated area on a golf course, such as a water hazard, a sand trap, or any arbitrary area on a course or hole. Such a rule or requirement may promote risk-averse play.

In some embodiments, the total hole time (and consequently total course time) may comprise the actual time to complete the hole, plus the added shot time, plus the penalty time.

In yet another embodiment, the method may require determining a bonus time (or point) deduction by multiplying at least one predetermined amount of time by a number of bonus occurrences, wherein said bonus occurrences may comprise any type of bonus occurrence, such as hitting a ball into a designated bonus area, hitting the ball using a bonus type of club, finishing a hole within a predetermined amount of time, completing a bonus milestone, and the like. In some embodiments, the designated bonus area may be any type of area on a golf course (or off a golf course). In some embodiments, it may be an adventurous bonus area, such as a forest, sand trap, and the like. The bonus milestone may be any kind of bonus milestone, such as, but not limited to, completing something within a predetermined amount of time or within a predetermined of strokes, or using a predetermined set of clubs, and the like. In some embodiments, the bonus occurrence may be a trick shot, such as a between the legs or eyes-closed shot. In some embodiments, the bonus time deduction could be a means to incentivize risky or adventurous play, or a means for catching up to an opponent or earning additional points or time.

In some embodiments the total hole time may comprise the actual hole time plus the added shot time, plus the penalty time (if applicable), minus the bonus deduction time.

In some embodiments, the total score may be based on the total hole time and may be attributed to the team as a whole.

In some embodiments, the method may comprise allowing individual team members to communicate using at least one wireless device, such as a communications device. The communications device may be any kind of device, such as an audio device, which may include a walkie talkie, microphone, wireless phone, and the like, a video device, such as camera, and the like, an audio-video device, such as a PDA, tablet PC, or smartphone, or a data communications device. The communications devices may use a local network, such as a WiFi network, a WiMax network, Zigbee, and the like, or may use a wider network, such as a GSM network or the internet to communicate. The players may wear or carry the wireless devices on their bodies or in their golf bags while playing.

In some embodiments, the wireless device may be any of those embodiments of wireless or communications devices described in any of the patent applications and patents mentioned in the priority claim above, all of which are incorporated by reference in their entirety.

In some embodiments, communicating using at least one wireless device comprises transmitting plays, shots, or strokes, or types thereof, player location, ball location, club selection, or course conditions, such as weather, greens conditions, hazards, wind, and the like. The player location or ball location may be calculated using a GPS device. By allowing communication using wireless devices, players may be allowed to strategize their game remotely and during the game.

Wireless communications may be useful to team members since it allows them to communicate across distances, and in cases where players are already positioned along the course, waiting to take their next turn.

It should be noted that since some embodiments call for time to be a factor in scoring, team members may want to disperse themselves throughout the course, being ready to hit the next shot as soon as it lands near them. Wireless communications would be especially effective because team members (including coaches) would be able to communicate during games.

In some embodiments, the team may comprise a coach, wherein the coach may keep track of time, may select play or shot types for the players, may select clubs, and may choose players for performing specific shots. The coach may communicate with the players using the wireless communications device. The coach may be positioned remotely from the course, such as in a coaches viewing box, wherein a plurality of display devices may show the activities on the golf course and a means for allowing communications between coaches and players alike.

In one embodiment, the method may require that team members abstain from using certain equipment, such as golf clubs, or particular types of golf clubs, golf balls, golf bags, golf carts, pull carts, tees, and the like.

In yet another embodiment, the method may require determining at least one hole winner by comparing a first total hole time of at least one first team and a second total hole time of at least one second team.

In some embodiments, the method may require that when a first team catches up to a second team in play, the second team must let the first team play through. The second team may be penalized for playing too slow, so in some embodiments, the amount of time it takes the first team to play through may be added to the second team's total hole time. This may encourage speedy and competitive play between teams.

The method, in accordance with one embodiment, may comprise determining a hole score, which may be measured in points or time, based on the total hole time. In yet a further embodiment, the method may call for determining a total course time based on the sum of the hole times for all the holes played.

In yet a further embodiment, the method may comprise determining a total score (which may be measured in time or in points) based on the total course time.

The method may yet further comprise determining a winner by comparing a first total score of at least one first team and a second total score of at least one second team.

The principles of the present disclosure may be applied to all types of computers, systems, and the like, include desktop computers, servers, notebook computers, personal digital assistants, and the like. However, the present disclosure may not be limited to the personal computer.

In some embodiments, the method may call for the traditional golf handicapped system to be implemented where the handicap may be based on either strokes, time, or points.

Referring now to FIG. 1C, a diagram depicting a system 150 for carrying out a method for conducting a reality golf television show is shown in accordance with one embodiment, wherein the method comprises conducting a selection process, wherein the selection process comprises: a first component based on participants' driving range ability, oral skills, attitude, and golf knowledge, amongst other things, a second component based on participants' golf course performance, such as score, how well they putt, chip, drive, and the like, wherein the selection is performed by collecting votes from viewers via a communications network 152; conducting a team-play golf tournament; and follow each of the television show's participants with a camera and recording their everyday lives throughout the television show.

In some embodiments, the method may comprise broadcasting the television show through any medium, including television, internet, or radio.

In some embodiments, the participants comprise of teams, wherein each team comprises at least one golfer, or player, at least one coach, and at least one assistant. The participants may be pre-screened in larger auditions, which may be performed across the country. In some embodiments, laypeople may be the participants, while in other embodiments the participants may be professional golfers.

In some embodiments, the participants may provide private commentary on the show, which is recorded and showed to viewers. The private commentary may comprise personal insight, rants, reviews, journal entries, and the like.

In some embodiments, viewers may base their votes on the commentary. The assistants may provide certain commentary, such as which golfer or player they feel are strongest. The coaches may provide private commentary regarding their own team, or other teams. The players/golfers may provide private commentary about each other or their coaches. In some embodiments, the commentaries may be shown through the week at the end of the show, and votes may be allowed to vote after viewing all of the commentary.

In some embodiments, viewers may be asked to vote on which participants, including players/golfers, should be selected for a particular team, or which players advance to the next round of selection or play, based on the following attributes, which include, but are not limited to: good golf skills, good team skills, personal character, and work ethic. In a further embodiments, viewers may be asked to vote on which coaches should be selected for a particular team or advance to the next round of selection or play, based on the following attributes, which include, but are not limited to: ability to coach a golf game, ability to make judgment calls, emotional intelligence, communication skills, and leadership skills.

For the viewer voting process, each attribute may be assigned a predetermined point value that may be tallied together to select a winner.

In some embodiments, votes are collected from viewers via electronic devices 154, such as person computers, cell phones, lap tops, tablet PCs, and the like. In some embodiments, the communications network may comprise an open network, such as the internet or a GSM network, or a closed network such as a VPN, and the like. In some embodiments, a voting server 156 may be used to collect and tally votes submitted by viewers.

In some embodiments, the viewers may base their votes on private commentary provided by participants, while in other embodiments viewers may base their votes on the golf activities partaken by the participants or in everyday activities partaken by the participants.

In some embodiments, the first component may be performed before the second component and may act as a screening selection process before allowing participants to move onto the second component of the selection process.

In a preferred embodiment, the reality show may select the top ten golf states to shoot and film in, wherein each state has two week filming sessions, one week for selection, and another for pre-tournament. The first week selection may be based upon driving range ability, oral skills, attitude, and knowledge of golf industry questions. The second week may be based on golf course performance.

In a preferred embodiment, a producer who knows about golf may be selected to produce the show. The purpose of the show may be to demonstrate team spirit of golf that is played within a short period of time (such as 120 minutes).

An initial screening process may comprise of candidates having to practice and present themselves to the producers, and convince the producer why they must be chosen to play. Candidates may submit their applications via e-mail, or may post them on a website, such as through profile pages or videos, on websites, such as social media websites.

After considerable thought and review, the producer may select two groups, wherein each group comprises at least three golfers, one coach, and two assistants, which may be ladies, to help them prepare for selection and pre-tournament activities. The assistants may provide private commentary, which is recorded, and which may be shown to viewers.

In some embodiments, each team may practice in the morning, and play a game, such as a charity game, in the evening for a predetermined amount of time, such as two hours.

The games maybe played from Tuesday to Thursday, with a rest day on Friday. On Saturdays and Sundays, a state final selection tournament may be conducted. Also, on Friday, the following may take place:

The recorded private commentaries by the assistants may be played, as well as those by the coaches and players. In other embodiments, the coach and player commentaries may be played throughout the week.

By Friday, viewers will have had the chance to get to know the teams and how well they play and the various criteria by which they should be judged for selection. The viewers may then select which players and coaches are allowed to participate in the final tournament over the weekend.

In some embodiments, the tournament may be held on Sunday, while Saturday may serve as a day for the players and coaches who have been selected to prepare for the tournament on Sunday.

The day of the tournament, cameras may be set up all over the golf course to follow participants throughout the tournament.

In some embodiments, cameras may be following the participants throughout the daily lives, following their non-golf related activities. Such recording can be used by viewers to gauge participants' private characteristics, behavior, and composure.

In some embodiments, an announcement regarding who has been selected to play in the tournament may be performed on Saturday morning at the golf course or driving range. The winner would have limited time to prepare for the tournament the following day.

In a preferred embodiment, the reality show could communicate not only the golfing lives of the participants, but also the private lives of golfers to viewers, so that viewers can see how everyday people can work and lead normal lives but also practice golf. Accordingly, participants will be expected to maintain professional and personal commitments, such as those owed to their jobs, families, and friends. Diversion may be shown as well, such as communications with family members, good news, bad news, everyday life agonies and joys, so that viewers may determine whether participants have a life condition that will enable them to be the best golfers for the states.

In some embodiments, the reality show's broadcast may be limited to local areas, such as states or cities, or at the national level.

In some embodiments, all the winners from the various states may play at a grand slam tournament, which may be held at a prestigious golf course, such as Pebble Beach, Augusta National, and the like. The grand slam tournament's proceeds may be wholly or partially submitted to a charity, such as a Cancer Awareness Fund.

In a further embodiment, the winners of the grand slam tournament may be offered a chance to play in a professional golf tournament or tour, such as the PGA, Nike Tour, and the like.

In the various embodiments of golf games referred to throughout the present disclosure, it is understood that such games may be played according to the traditional rules of golf, or the rules of golf as described above with reference to FIGS. 1A and 1B, and the U.S. provisional patent applications 61/478,762, by Isaac S. Daniel, and 61/476,106, by Isaac S. Daniel, et al.

In some embodiments, the team-play golf tournament comprises the method for playing and scoring a golf game described above with reference to FIGS. 1A and 1B, such as, but not limited to, determining an actual time it takes a team to complete a golf hole, determining a number of strokes taken by the team in completing the golf hole, multiplying the number of strokes taken by the team in completing the golf hole by a predetermined amount of time to determine an added shot time, determining a total hole time by adding the added shot time to the actual time it takes the team to complete the golf hole, and recording the total hole time on a score keeping means, as well as the various other embodiments and variations described above with reference to FIGS. 1A and 1B.

### Hardware and Operating Environment

This section provides an overview of example hardware and the operating environments in conjunction with which embodiments of the inventive subject matter can be implemented.

A software program may be launched from a computer readable medium in a computer-based system to execute the functions defined in the software program. Various programming languages may be employed to create software programs designed to implement the system 100 and method 200 disclosed herein. The programs may be structured in an object-orientated format using an object-oriented language such as Java or C++. Alternatively the programs may be structured in a procedure-oriented format using a procedural language, such as assembly or C. The software components may communicate using a number of mechanisms, such as application program interfaces, or inter-process communication techniques, including remote procedure calls. The teachings of various embodiments are not limited to any particular programming language or environment. Thus, other embodiments may be realized, as discussed regarding FIG. 2 below.

FIG. 2 is a block diagram representing an apparatus 200 according to various embodiments. Such embodiments may comprise a computer, a memory system, a magnetic or optical disk, some other storage device, or any type of electronic device or system. The apparatus 200 may include one or more processor(s) 204 coupled to a machine-accessible medium such as a memory 202 (e.g., a memory including electrical, optical, or electromagnetic elements). The medium may contain associated information 206 (e.g., computer program instructions, data, or both), which, when accessed, results in a machine (e.g., the processor(s) 204) performing the activities previously described herein.

The principles of the present disclosure may be applied to all types of computers, systems, and the like, include desktop computers, servers, notebook computers, personal digital assistants, microcomputers, and the like. However, the present disclosure may not be limited to the personal computer.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

1. A method for conducting a reality golf television show, comprising:
a. conducting a selection process, wherein the selection process comprises:
i. a first component based on participants':
1. driving range ability;
2. oral skills;
3. attitude; and
4. golf knowledge
ii. a second component based on participants' golf course performance;
iii. wherein, the selection is performed by collecting votes from viewers via a communications network;
b. conducting a team-play golf tournament; and
c. following each of the television show's participants with a camera and recording their everyday lives throughout the television show.

2. The method of claim 1, further comprising broadcasting the television show through any medium, including television, internet, or radio.

3. The method of claim 1, wherein the participants comprise of teams, wherein each team comprises at least one golfer, at least one coach, and at least one assistant.

4. The method of claim 1, wherein the participants provide private commentary on the show, which is recorded and showed to viewers.

5. The method of claim 4, wherein viewers base their votes on the commentary.

6. The method of claim 3, wherein the assistants provide private commentary as to which players are the strongest.

7. The method of claim 3, wherein the coaches provide private commentary on their own team or other teams.

8. The method of claim 3, wherein the players provide private commentary about each other and their coaches.

9. The method of claim 3, further comprising allowing viewers to vote after having seen all of the commentary throughout the selection process.

10. The method of claim 1, wherein the viewer selection is based on which player portrays the following attributes:
a. good golf skills;
b. good team skills;
c. personal character; and
d. work ethic.

11. The method of claim 1, wherein the viewer selection is based on which coach portrays the following attributes:
a. ability to coach a golf game;
b. ability to make judgment calls;
c. emotional intelligence;
d. communication skills; and
e. leadership skills.

12. The methods of claims 10 and 11, wherein each is assigned a predetermined point value that will be tallied together to select the winner.

13. The method of claim 1, wherein votes are collected from viewers via viewers electronic devices.

14. The method of claim 1, wherein viewers base their votes on private commentary provided by the participants.

15. The method of claim 1, wherein viewers base their votes on the golf activities partaken by the participants.

16. The method of claim 1, wherein viewers base their votes on the everyday activities partaken by the participants.

17. The method of claim 1, wherein the team-play golf tournament comprises a method for playing and scoring a golf game, comprising:
a. determining an actual time it takes a team to complete a golf hole;
b. determining a number of strokes taken by the team in completing the golf hole;
c. multiplying the number of strokes taken by the team in completing the golf hole by a predetermined amount of time to determine an added shot time;
d. determining a total hole time by adding the added shot time to the actual time it takes the team to complete the golf hole; and
e. recording the total hole time on a score keeping means.

18. The method of claim 17, wherein the team-play golf tournament comprises requiring that the team comprise of a plurality of players, wherein each player is responsible for at least one specific skill or at least one specific shot.

19. The method of claim 18, wherein the specific skill is a type of skill selected from the group consisting essentially of: a driving skill, a putting skill, a chipping skill, a short iron skill, a long iron skill, a sand trap skill, a rough skill, and a trick shot skill.

20. The method of claim 18, wherein the specific shot is a type of shot selected from the group consisting essentially of, a drive, a fairway shot, a rough shot, a sand trap shot, a chip, a putt, a trick shot, a slice, a draw, a fade, a hook, a push, a pull, a backspin shot, a forward spin shot, a side spin shot, a lob, a skip shot, and a sky shot.

21. The method of claim 17, wherein the team-play golf tournament comprises requiring team members to take consecutive turns playing the same ball beginning with the tee off and continuing until the ball has been holed.

22. The method of claim 18, further comprising requiring that each team member charged with at least one specific skill or at least one specific shot play the ball in the lie that requires each team member's specific skill or specific shot.
